(19) United States
(12) Patent Application Publication
(10) Pub. No.: US 2007/0266305 A1
(43) Pub. Date: Nov. 15, 2007

(54) System and method for monitoring user behavior with regard to interactive rich-media content

(76) Inventors: David Cong, San Jose, CA (US); Richard Liu, Jiangsu (CN); Jim Miao, Jiangsu (CN); Tommy Zhao, Jiangsu (CN); Andrew Wei, Jiangsu (CN); Esther Poon, San Jose, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/432,208

(22) Filed: May 10, 2006

(51) Int. Cl. G06F 17/00

(52) U.S. Cl. 715/500.1

(57) ABSTRACT

A method comprising enabling selection of interactivity control points of interest in media content; forwarding identification of at least one interactivity control point of interest to a wrapper generator; and attaching at least one script to the media content to monitor the at least one interactivity control point of interest when the media content is executed. The interactivity control points may include clickable points and mouse movement. The media content may include Flash media. The at least one script may be capable of monitoring all instances of consumer interaction with the interactivity control points occurring during media content playback. The method may also comprise generating configuration data for configuring the script to monitor only a portion of the instances of the consumer interaction with the interactivity control points occurring during media content playback.

### TECHNICAL FIELD

This invention relates generally to online advertising, and more particularly provides a system and method for monitoring user behavior during interactive rich-media presentations.

### BACKGROUND

Today, rich-media plays a critical role to accelerating internet sales and marketing, since interactive access is getting easier and more popular. While internet traffic holds significant consumer information, data is getting significantly complex to capture, comprehend and analyze.

A company's success often depends on the cost-effectiveness of gaining and retaining consumer attention. Rich-media offers one solution to this need. However, rich-media complicates the following key success enablers and measuring factors:
Deep (into the media organization) and distributed media content management;
Data analytics that create vital business intelligence; and
Strategic deployment of an attention loop that will evolve in step with significant developments in consumer behaviors and media business models.

An easy-to-use open-standard vehicle is needed to enable the understanding of consumer internet activities, to allow a closer look at their needs, and to empower more return on investment from internet showcases. The following questions need answering:
How does one evaluate an existing rich-media product?
How does one dynamically configure or collect user traffic on an existing rich-media product?
How does one visualize the user experience and track consumer interactive activities?
And how does one generate customized reports with deep analysis of consumer behavior?

### SUMMARY

In one embodiment, the present invention provides a method comprising enabling selection of interactivity control points of interest in media content; forwarding identification of at least one interactivity control point of interest to a wrapper generator; and attaching at least one script to the media content to monitor the at least one interactivity control point of interest when the media content is executed. The interactivity control points may include clickable points and mouse movement. The media content may include Flash media. The at least one script may be capable of monitoring all instances of consumer interaction with the interactivity control points occurring during media content playback. The method may also comprise generating configuration data for configuring the script to monitor only a portion of the instances of the consumer interaction with the interactivity control points occurring during media content playback. The portion of the instances may be determined by the customer on a point-by-point basis.

Another embodiment includes a system comprising a selector for enabling selection of interactivity control points of interest in media content; a data management module for forwarding identification of at least one interactivity control point of interest to a wrapper generator; and a wrapper generator for attaching at least one script to the media content to monitor the at least one interactivity control point of interest when the media content is executed.

Another embodiment includes a method comprising receiving media content having at least one attached script capable of monitoring interactivity control points; obtaining configuration data identifying which interactivity control points to monitor; configuring the script to monitor at least one interactivity control point in accordance with the configuration data; and executing the media content and the configured script. The script may be configured to monitor interactivity control points including clickable points and mouse movement. The media content may include Flash media. The at least one attached script may be capable of monitoring all instances of consumer interaction with the interactivity control points occurring during media content playback.

Another embodiment includes a system comprising media content having at least one attached script capable of monitoring interactivity control points; configuration data identifying which interactivity control points to monitor, the attached script including address information for identifying the configuration data; and a browser for downloading the media content and the configuration data and for executing the media content and the attached script, the execution of the attached script dynamically configuring the script to monitor at least one interactivity control point.

### BRIEF DESCRIPTION OF THE DRAWINGS

FIG. 1A describes a first architecture illustrating an example process of a rich-media content networking service.

FIG. 1B describes a second architecture illustrating another example process of a rich-media content networking service.

FIG. 2 is a table that illustrates a couple example business flows.

FIG. 3 shows an example of an architecture illustrating the rich-media process in a market promotion for an enterprise customer contracted by an agent.

FIG. 4 is a table illustrating example roles and responsibilities that may be needed to profile a project.

FIG. 5 is an example ICP/script table illustrating different types of ICPs and the corresponding handling of them.

FIG. 6 illustrates example click data for three consumer click interactions.

FIG. 7 shows example trace data for mouse movement from left to right, while viewing the “steering panel” area for 1.26 seconds.

FIG. 8 shows a collected binary data record structure example after the packaging process.

FIG. 9 describes an example client and server data and control flow.

FIG. 10 is a table illustrating example measurements available for reports.

FIG. 11 is a graph illustrating the number of clicks/clients/views per week.

FIG. 12 is a graph illustrating the number of clicks for each subject item.

FIG. 13 is a graph illustrating the PreClick duration per subject.

FIG. 14 is a block diagram illustrating an architecture for establishing rich-content review, analysis, and reporting.

FIG. 15 is a block diagram illustrating details of a report server.

FIG. 16 is a block diagram illustrating details of the configuration wizard.

FIG. 17 is a block diagram illustrating details of the wrapper generator.

FIG. 18 is a block diagram illustrating details of a wrapper attached to media content.

FIG. 19 is a block diagram illustrating details of a computer system.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

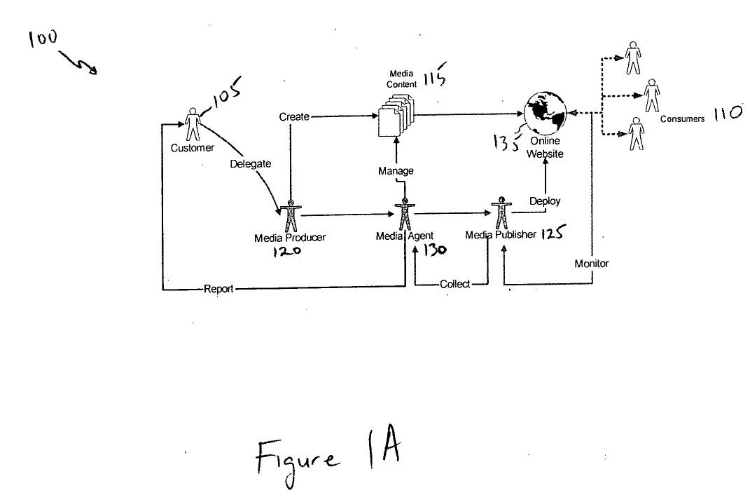

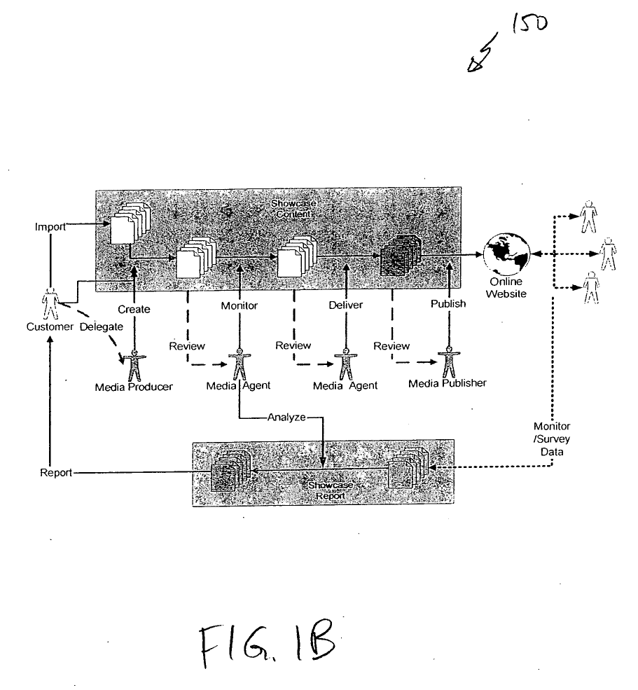

The solution begins with understanding various business flows, and systematically decomposing the business flows into traceable steps. FIG. 1 describes an architecture 100 illustrating an example process of a rich-media content networking service. Architecture 100 includes the following characteristics:
1. The process involves several parties including the customer 105 who owns the media content 115 and the consumer 110 who accesses the media content 115.
2. The process has key business operations including delegation by a customer 105, media creation by a media producer 120, media management by a media agent 130 (which may be the same as the media producer 120), media publication by a media publisher 125 (in this example via deployment on an online website 135), media traffic monitoring by the media publisher 125, and media traffic collection and reporting by a media agent 130.
3. The media support companies may be divided in two separate roles: agent/producer 120/130 as a single party and publisher 125 as a second party.

The architecture 100 illustrates the following business operations:
1. Media Creation & Generation—this path is driven by the customer 105 to delegate creation of business-related media content 115 to a media producer 120.
2. Media Publication and Delivery—this path is driven by the customer 105 to delegate a media publisher 125 to deploy the media content 115 onto an online website 135.
3. Media Monitoring—this path is handled by the publisher 125, the media agent 130 or a 3^{rd} party (not shown) to monitor the online content 115 and collect the traffic.
4. Data Analysis and Reporting—this path is handled by the agent 130 or a 3^{rd} party to analyze the collected traffic and to generate reports indicating business media impact and result for customers 105.

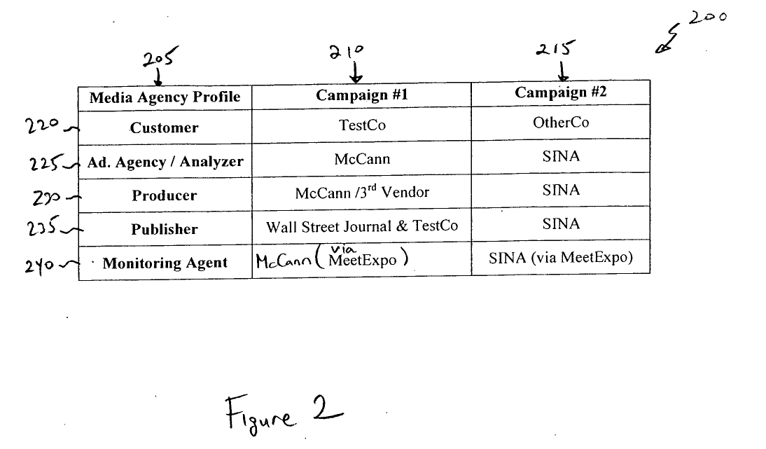

As expected, this is just an example business flow. Different markets and different embodiments have different business flows. For example, some named agents 130 may also be producers 120 and publishers 125. FIG. 2 illustrates a second architecture 150 illustrating another example process of a rich-media content networking service. Because of the various parties involved in rich-media content operations, the best solution should allow the independence of each operational phase, e.g., the customer should have the flexibility to assign each phase to a different agency or use one or more services in the process.

FIG. 2 is a table 200 that illustrates a couple example business flows. Column 1 of table 200 illustrates example roles (media agency profiles) for a particular business flow. Column 2 of table 200 illustrates example companies acting under those roles for a first campaign. Column 3 of table 200 illustrates example companies acting under those roles for a second campaign. The example roles include customer 220, ad agency/analyzer 225, producer 230, publisher 235 and monitoring agent 240.

According to campaign #1, the customer 205 is TestCo, the ad agency/analyzer 225 is McCann, the producer 230 is McCann and a 3^{rd} party, the publisher 235 is the Wall Street Journal and TestCo, and the monitoring agent 240 is McCann (via MeetExpo). In campaign #2, the customer 205 is OtherCo, the ad agency/analyzer 225 is SINA, the producer 230 is SINA, the publisher 235 is SINA, and the monitoring agent 240 is SINA (via MeetExpo). In the first campaign, the media content producer is different than the publisher, which is different than the monitoring agent. In the second campaign, the producer, publisher and monitoring agent are essentially the same party. Without the teachings of the present invention, it may have been more difficult in the first campaign to establish a mechanism for monitoring user behavior during the presentation of the media content, because of the various parties involved in the media content creation, publication and monitoring process. However, the technology of the present invention may make establishing a monitoring mechanism for the situation having the first campaign profile much simpler.

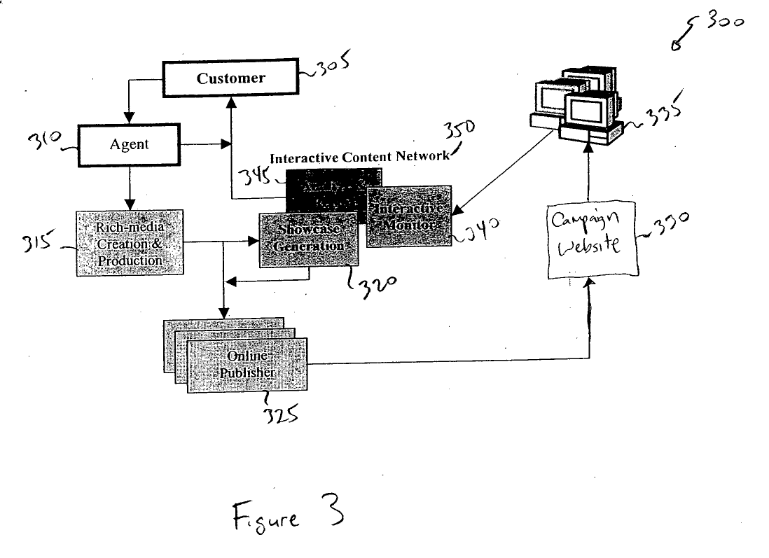

FIG. 3 shows an architecture 300 illustrating an example rich-media process in a market promotion for an enterprise customer 305 contracted by an agent 310.

Architecture 300 includes a customer 305 in communication with an agent 310, who communicates with the customer 305 and a rich-media producer 315. The producer 315 is in communication with a showcase generator 320. The producer 315 and showcase generator 320 are in communication with an online publisher 325, which launches a campaign website 330. Consumers 335 view the campaign website 330, which includes a mechanism to send media traffic to an interactive monitor 340. An analyzer/report generator 345 obtains the media traffic from the interactive monitor 340, and generates reports for the customer 305. The showcase generator 320, interactive monitor 340, and analyzer/report generator 345 may also belong to an interactive control network 350 implemented on a single server or server farm.

The general process of business operations involved in architecture 300 include profiling a project, generating the showcase, distributing the showcase, monitoring interactivity, collecting the monitored data, buffering and packing the collected data, and generating reports. Each of these steps is described in more detail below.

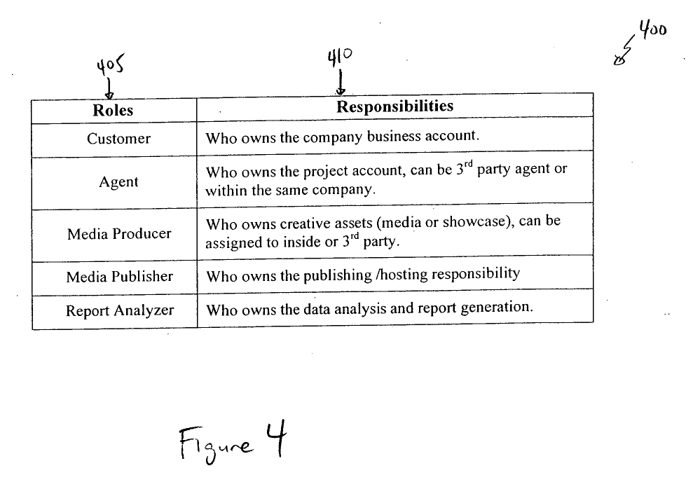

Profiling a project—This step specifies the flows and players of the project. Based on the process flow, a project is ready to start once the company's business services and associated owners/partners are specified. Identification should include identifying event goals, agencies involved, online hosts, publishers, and budget scope. FIG. 4 is a table 400 illustrating example roles and responsibilities that may be needed to profile a project. Column 405 lists example roles including customer, agent, media producer, media publisher and report analyzer. Column 410 lists example responsibilities for each of the different roles listed in column 405.

Generate the showcase—Rich-media producer 315 generates the rich media content. The rich-media producer 315 may be inside or outside the company. Once the rich-media content is generated, the rich media producer 315 sends the rich-media content to the showcase generator 320. The showcase generator 320 wraps the rich-media content with “monitor logic,” also known as a script or a plug-in. When media content is wrapped by script, it is referred to herein as a “showcase.”

When a project is identified, the media content is produced by the designated rich-media designer and production house. Rich-media production is usually done by a 3^{rd} party independently, and therefore is not covered in this document.

Once the rich-media content is created, the content needs to be examined for control points. Then, control scripts need to be added to monitor those control points. This is called “showcase wrapping.” The showcase generator 320 (possibly with the help of the user) decomposes the media content into discrete functional areas. Each discrete functional area can then be analyzed to identify interactive control points (ICPs). Then, a script can be added to the media content to monitor each control point. Each control script may include a list of action codes associated with the identified traceable interactive control points. Note that the scripting process is preferably transparent to the customer and/or consumer (which means the scripts preferably do not modify or impact the media content or existing production results).

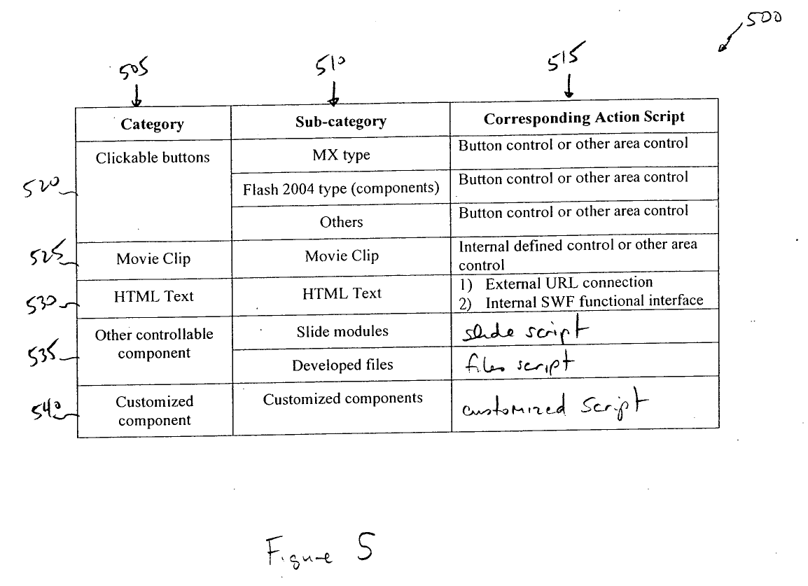

The following are example Flash-based showcase generation procedures:
a. Read Flash files;
b. Verify that the file is a non-wrapped file (generate error for already wrapped file);
c. Identify Flash version (different version may require a different decoding program);
d. Decode Flash program and plug-in corresponding monitor scripts, including showcase ID, initialization data, monitor control interface, default network/domain data, etc.
e. Decode Flash to identify all types of embedded ICPs, and plug-in corresponding ICP identifier and control script. FIG. 5 is an example ICP/script table 500 illustrating different types of ICPs and the corresponding handling of them. Table 500 has a first column 505 that lists categories of ICPs, a second column 510 that lists subcategories of ICPs, and a third column 515 that lists corresponding action script(s) for each subcategory. Example categories of ICPs include clickable buttons 520, movie clips 525, HTML text 530, other controllable components 535, and customized components 540. Example subcategories of clickable buttons 520 include MX type, Flash 2005 type (components), and other types. Example subcategories of other controllable components 535 include slide modules and developed files. All other example subcategories in table 500 are the same as the respective categories. The corresponding script for each of the subcategories of clickable buttons 520 includes script for button control and other area control. The corresponding script for the movie clip includes script for monitoring internal defined control or other area control. The corresponding script for HTML text 530 includes script for monitoring the external URL connection and the internal SWF functional interface. The corresponding script for the slide module subcategory of other controllable components 535 includes script for monitoring the slide. The corresponding script for the developed file subcategory of other controllable components 535 include script for monitoring file control. The corresponding script of the customized components includes script for monitoring the customized controls.
f. Repeat step (e) for all files in the same package. All files in the same package may be processed at the same time with the same showcase ID to avoid data out-of-sync problems.

Distribute the “showcase”—The showcase may be published onto an online website 330 via an online publisher 325. The online publisher can be a designated web publisher.

To achieve maximum efficiency and performance, customers may choose local online hosting vendors associated with different publishers. This minimizes coordination in media content version control, which is a popular problem in most projects, especially for special advertisement campaigns may have several editions in the early deployment period.

Monitor interactivity—For every consumer 335 that downloads the showcase, the consumer's click and mouse movement may be monitored and logged by the showcase script, until the consumer 335 closes the browser session.

It is important to determine which interactions of a showcase should be monitored.

First, interaction control points (ICPs) are potential consumer interactions with the rich-media content that can be tracked. These interactions include click, close, replay, fill-play, mouse-over, etc. In general, there are two types of interactions that can be tracked, namely, clickable points and mouse movement.

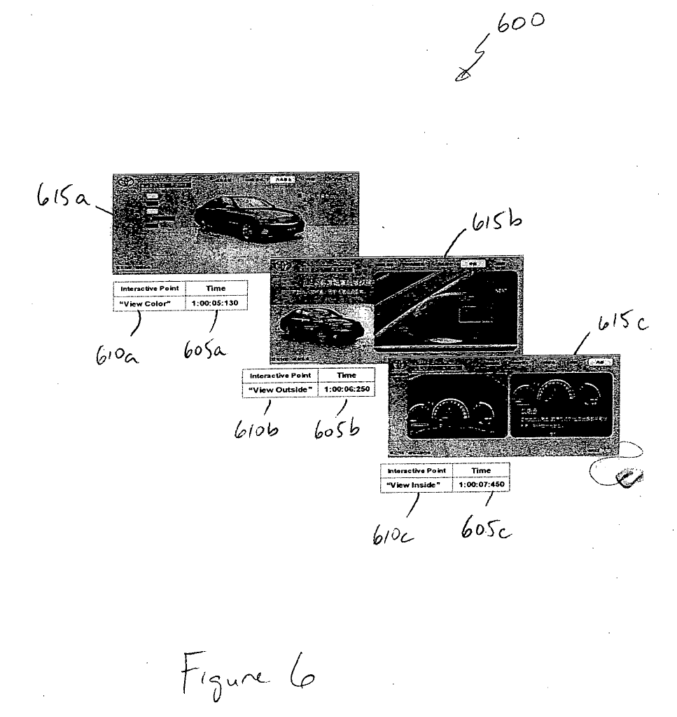

Clickable points (by mouse or keyboard) can be either a static control point or a dynamic control point. A static control point has only one data definition associated with it. A dynamic control point has multiple data definitions associated with the one clickable point, which are usually downloaded from pre-built data files via action-scripts, or database. Types of clickable point activity include “click,” “mouse-over,” “mouse-out,” etc. FIG. 6 illustrates example click data 605a-605c for three consumer click interactions 610a-610c. Images 615a-615c illustrate the images that may be seen by the consumer, as caused by the click interaction 610a-610c.

An associated plug-in script is attached to each noted ICP and generates the monitored data representative of the consumer interaction with that ICP when the content is playing, e.g., the Flash is running. Since there are various types of control action possibilities, the monitoring scripts may vary. However, the output data may all have the same format.

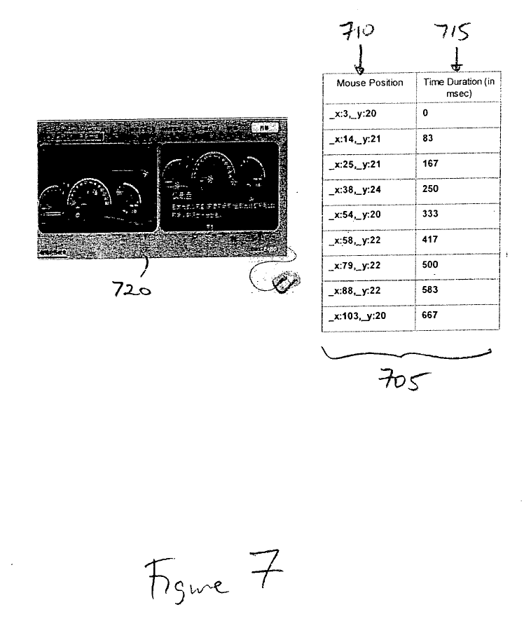

For mouse movement, a script may be attached to the mouse movement controls and may collect a trace of mouse position periodically, e.g., every 1/60 second or at the frame rate. This may be implemented by decoding each Flash frame and attaching the plug-in monitoring scripts (max. 60 frames per second or up to the frame rate). Since Flash is frame-based, the monitoring script need not be complex. FIG. 7 shows example trace data 705 for mouse movement from left to right, while viewing the “steering panel” area 720 for 1.26 seconds. Column 710 of trace data table 705 identifies mouse position (e.g., x and y coordinates), and column 715 of trace data table 705 identifies duration of the time the mouse spent at that position.

It is also important to determine when consumer interaction monitor data should be generated. When one client downloads a website, containing rich-media content with the plug-in, the plug-in will automatically read the “client interface control setup” from remote locations to configure monitor operations, accordingly. When the user interacts with an ICP or causes mouse movement, the control script will generate a monitor record with proper details, and will store the monitor data at a client-side storage buffer. In one embodiment, when the stored data reaches a specified limit, the script via the consumer 335 will transmit the contents of the storage buffer to the interactive monitor 340. It will be appreciated that the specification herein sometimes refers to the consumer (specifically meaning the human operator) and the client (specifically meaning the human operator's computer) interchangeably. However, one skilled in the art will know that the consumer is controlling the client, which executes the responsive computer instructions.

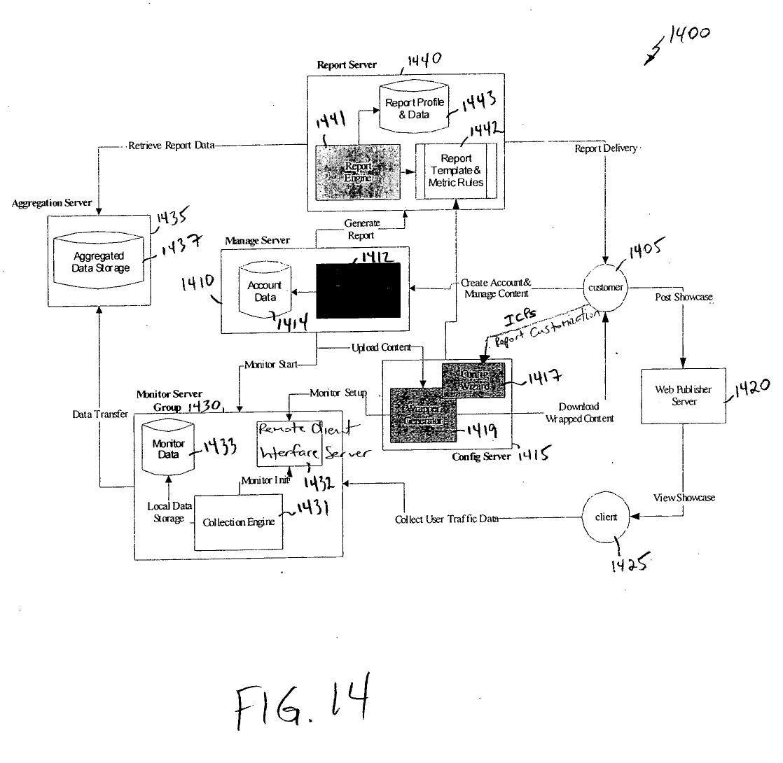

The client interface control setup, which can be download from a remote client interface server (see FIG. 14), contains data transfer protocol information, transmission rules, monitor data types, a list of current interactive monitor 340 locations, and session control parameters and logic for the monitoring plug-in.

Collect monitor data—The plug-in, running along with the rich-media content, periodically sends the collected monitor data to the specified interactive monitor 340. The plug-in may send the collected monitor data at prescribed times, periodically, after predetermined events (such as the accumulation of a certain amount of data), after each consumer interaction, etc. Monitor data collection may be sampled in each client 335 and then transferred to the interactive monitor 340, via the protocol configured by an “action control interface file” included with the plug-in or downloaded with the “client interface control setup” when the consumer 335 plays the showcase, e.g., using HTTP.

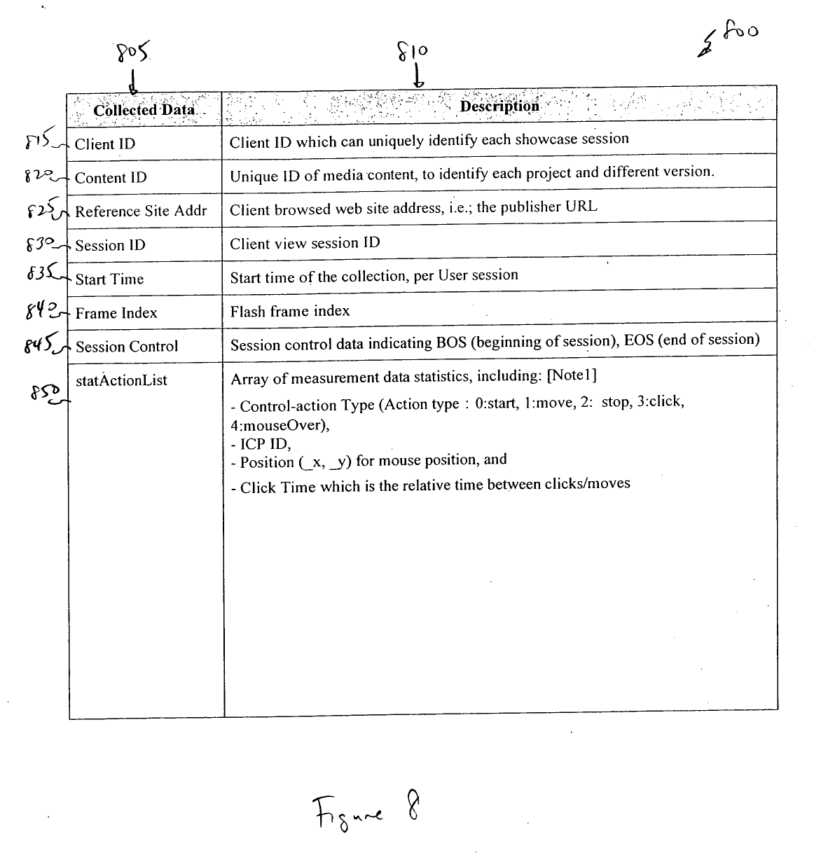

Monitor data once received are collected and packed in the interactive monitor 340 for session level handling. FIG. 8 shows a collected binary data record structure 800 example after the packaging process. Column 805 of structure 800 lists the collected data. Column 810 of structure 800 lists descriptions of the collected data. In this example structure 800, collected data includes a client ID 815 (uniquely identifying each showcase session), a content ID 820 (uniquely identifying media content to identify each project and different versions), a reference site address 825 (including the publisher URL to which the consumer accessed), a session ID 830 (uniquely identifying the client view session), a start time 835 (identifying the start time of the collection, per user session), a frame index 840 (identifying the Flash frame), a session control 845 (identifying the beginning and end of the session), and an action list 850 (including monitor data such as clickable point data and mouse movement data).

Buffer and pack the collected data—In this embodiment, the interactive monitor 340 is responsible for collecting, analyzing, packing and storing all monitor data for further processing.

With centralized traffic, the interactive monitor 340 is designed to handle high volume concurrent inbound data throughput by using a distributed and multi-tiered server architecture, to allow package flow from multiple public websites into distributed interactive monitor 340, and to store the incoming traffic as a group to a database.

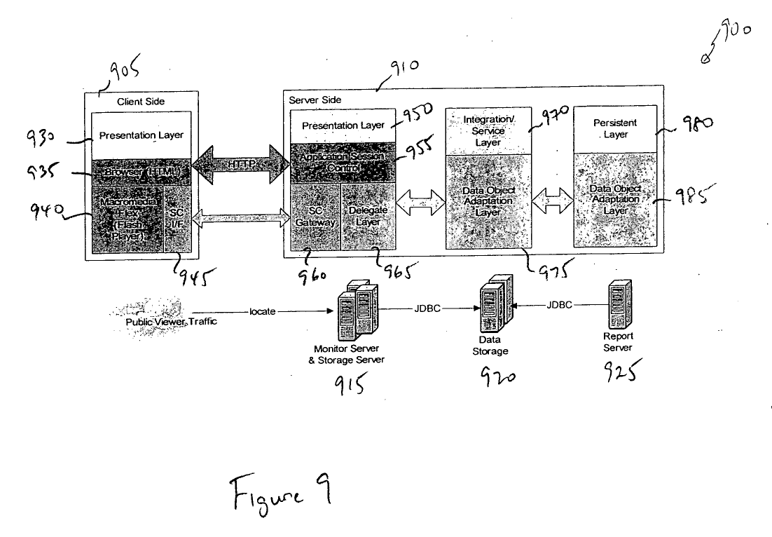

FIG. 9 describes an example client 905 and server 910 data and control flow. The server 910 includes a monitor and storage server 915 (which may be similar to interactive monitor 340), a data storage 920, and a report server 925 (which may be similar to analyzer/report generator 345). The client 905 may be similar to consumer 335. The client 905 includes a presentation layer 930, a browser 935, a Flash player (e.g., Macromedia Flex) 940, and a system control interface (SC I/F) 945. The monitor server 915 in the server 910 includes a presentation layer 950, an application session control 955 in communication with the browser 935 in the client 905, a system control gateway 960 in communication with the SC I/F 945 in the client 905, and a delegate layer 965. The data storage 920 in the server 910 includes an integration service layer 970 and a data object adaptation layer 975 in communication with the delegate layer 965 of the monitor and storage server 915. The report server 925 includes a persistent layer 980 and a data object adaptation layer 985 in communication with the data object adaptation layer 975 in the data storage 920.
A) Monitor data gathered by the client 905 may be packaged as binary “action records” (AR) and buffered in local memory until the end of the session, or until a session timeout in the interactive monitor 340 session control gateway. An end-of-session may be detected by the monitoring script on the client 905, based on the client session timeout value. The session timeout may be controlled by the monitor and storage server 915 when an active session exceeds the reasonable predefined time interval. Any showcase traffic in one session may be sent to the monitor and storage server 915. Connectionless showcase traffic may be merged together in one session on the monitor and storage server 915.
B) All action records of each client 905 may be combined as one “Client Record” (CR), and thousands of Client Records may be forwarded to the next layer for synchronization and consolidation. This can be implemented at a local server, together with the monitor server 915, or at a remote server (without the monitor server 915). The monitor server 915 may be in charge of collecting client 905 traffic. Every web server may handle at least one-thousand concurrent user actions recording in one second.
C) After tens of thousands of action records are collected, the action records may be stored in the data storage 920. Action records should be separated by day. Every data storage 920 may be able to handle hundred of thousands of concurrent showcase traffic inputs.
D) Report server 925 is in charge of report and project administrative operations.

Report server 925 retrieves action records from the data storage server 920 and performs routine data analysis and reporting. Once retrieved, action records can be maintained at external storage, if desired.

Generate reports—Based on customer specifications, the analyzer/report generator 345 (or report server 925) accesses the data stored interactive monitor 340 (e.g., in data storage 920) for sorting and report generation, possibly using pre-defined templates and/or templates customized for a particular customer 305. The analyzer/report generator 345 then sends the report(s) to the customer 305.

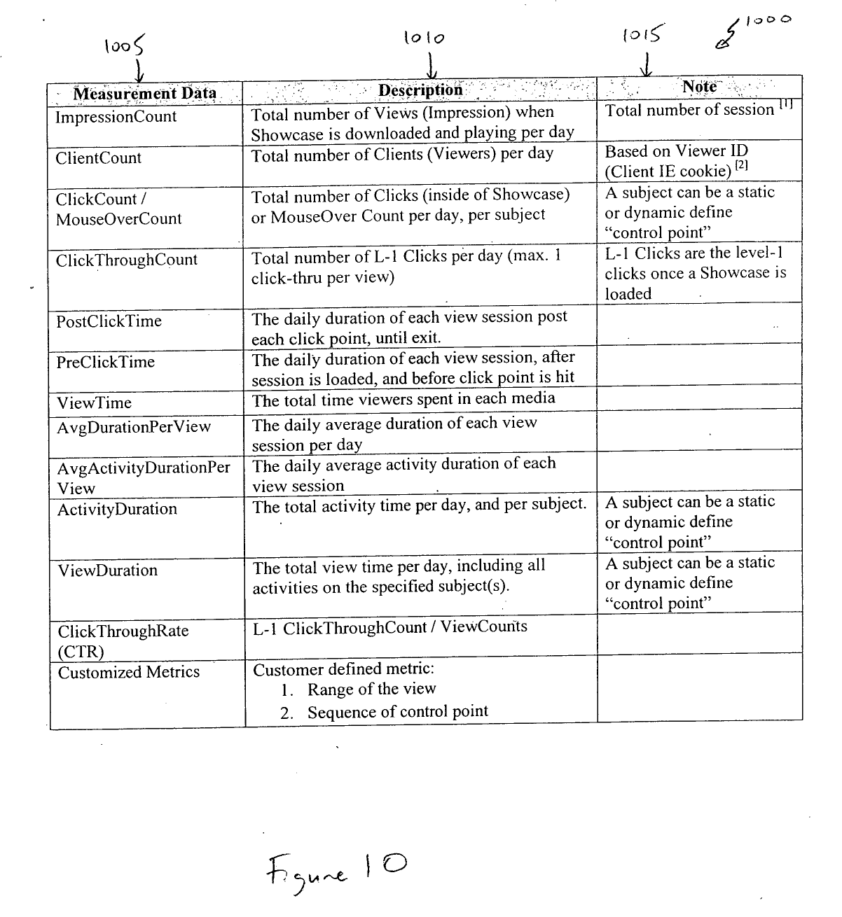

Besides the standard set of monitor points, customers 305 can define additional monitor paths. Media analysis defines which consumer interactions are to be tracked and reported. Reports are generated per customer configuration in each project profile. FIG. 10 is a table 1000 illustrating example measurements available for reports. Column 1005 lists measurement data. Column 1010 illustrates the description of the measurement data. And, column 1015 illustrates notes relative to each measurement data. Per table 1000, example measurement data includes ImpressionCount, ClientCount, ClickCount/MouseOverCount, ClickThroughCount, PostClickTime, PreClickTime, ViewTime, AverageDurationPerView, AverageActivityDurationPerView, ActivityDuration, ViewDuration, ClickThroughRate, and CustomizedMetrics.

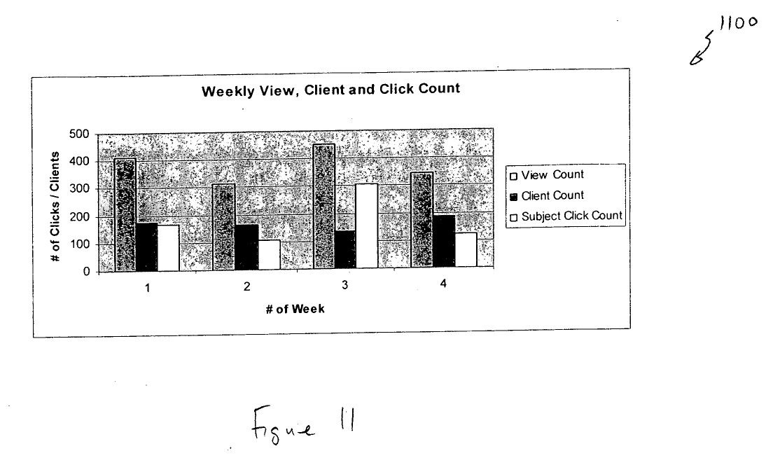

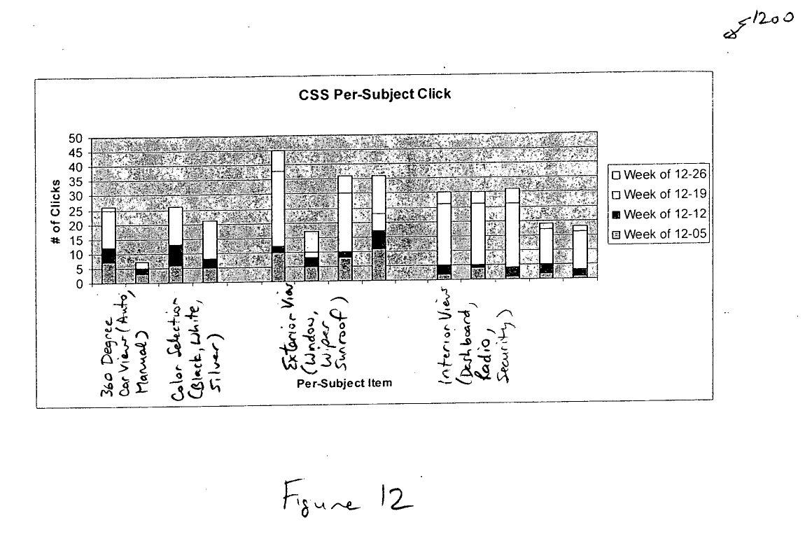

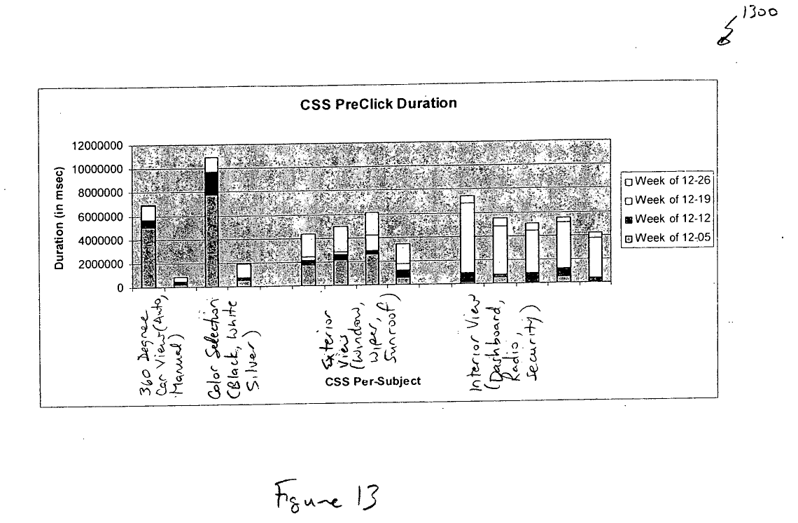

FIG. 11-13 illustrates a few example reports. FIG. 11 is a graph 1100 illustrating the number of clicks/clients/views per week. As shown, in week 1, there were over 400 view counts, around 180 client counts, and around 175 subject click counts. FIG. 12 is a graph 1200 illustrating the number of clicks for each subject item. As shown, there were 7 clicks on backpack in week 1, 12 clicks in week 2, 25 clicks in week three, and 26 clicks in week 4. FIG. 13 is a graph 1300 illustrating the PreClick duration per subject. As shown, the PreClick duration was 5 million milliseconds for week 1, 5.8 million milliseconds for week 2, 7 million milliseconds for week 3, and 7 million milliseconds for week 4.

FIG. 14 shows a network architecture 1400 to enable showcase generation, monitoring and reporting. Network architecture 1400 includes a customer 1405, a manage server 1410 (including a customer manage server 1412 and account data 1414), a configuration server 1415 (including a configuration wizard 1417 and a wrapper generator 1419), a web publisher server 1420, a client 1425, a monitor server group 1430 (including a collection engine 1431, a remote client interface server 1432, and monitor data store 1433), an aggregation server 1435 (including aggregation data storage 1437), and a report server 1440 (including a report engine 1441, report templates and metric rules 1442, and a report profile and data store 1443).

Generally, the customer 1405 creates an account and manages the media content via the manage server 1410. The customer manage server 1412 develops the media content, and may be managed by the enterprise or a third party advertisement development company. The media content may include interactive content, Flash media, and many levels of depth and redirection. The manage server 1412 may store the media content and other account information in account data 1414.

The customer 1405 may interact with the configuration wizard 1417, which enables the customer 1405 to select interactivity control points (ICPs) of interest to be monitored and report customization information (which may be determined from the ICPs selected). As stated above, the ICPs may include clickable points, mouse movement, slider control movement, scroll bar movement, playback control such as pause, fast forward and rewind, etc. The configuration wizard 1417 enables the customer to review the media content, select interactivity points of interest, and collect the ICP data.

The manage server 1410 uploads the media content to the configuration server 1415. The wrapper generator 1419 of the configuration server 1415 uses the ICPs selected by the customer 1405 via the configuration wizard 1417 and control scripts to wrap the media content. The configuration server 1415 then sends the wrapped content to the customer 1405.

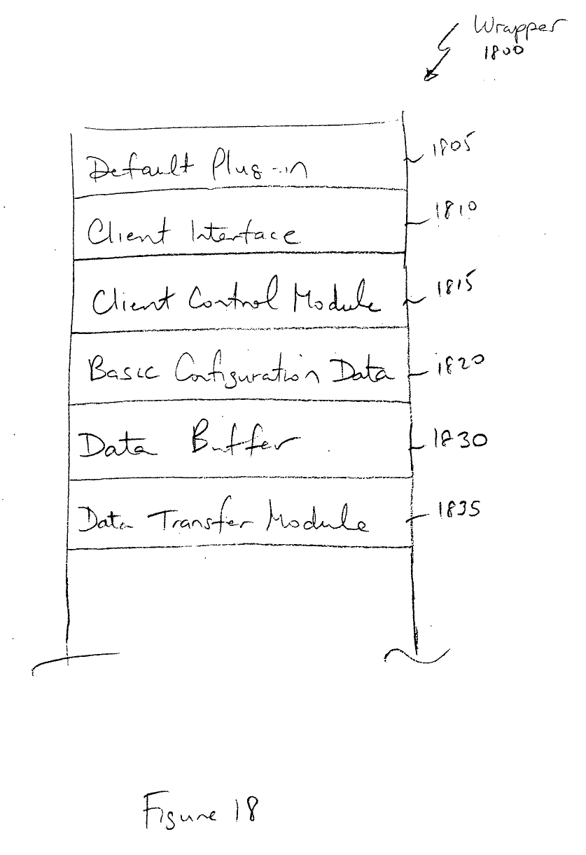

The wrapper generator 1419, possibly automatically or possibly as controlled by a programmer, attaches control scripts for monitoring the selected interactivity points of interest to generate the wrapped content, i.e., the showcase. The wrapped content essentially includes the media content for unmodified presentation and at least one control script attached to the media content for monitoring consumer interaction with the media content. For example, if the customer selected a particular clickable point in the media content, the attached script monitors the particular clickable point. If the customer selected to monitor mouse movement over a particular image during a particular frame sequence, then the attached script monitors mouse movement at the particular time. The wrapper attached to the media content is described in greater detail with reference to FIG. 18.

The customer 1405 posts the wrapped content via the web publisher server 1420. The web publisher server 1420 enables the consumer (client) 1425 to view the showcase. The customer (client) 1425 includes a browser, e.g., Microsoft Internet Explorer or Netscape Navigator, for browsing. The customer 1425 downloads the showcase. While executing the media content, the customer 1425 executes the attached scripts. Executing the scripts, the client 1425 monitors consumer interactivity with the media content, and captures user traffic data in a local buffer (see FIG. 18), and transmits the captured user traffic data to the monitor server group 1430.

The monitor server group 1430 collects consumer-traffic data from the consumer 1425, and sends monitor data to the aggregation server 1435. The monitor server group 1430 awaits a start-monitor from the manage server 1410 before starting to monitor the consumer-traffic and may obtain setup data from the configuration server 1415 to determine what to monitor. The manage server 1410 may request report generation from the report server 1440. The report server 1440 retrieves data from the aggregation server 1435, generates reports based on templates and metric rules 1442 received from the configuration server 1415, stores the reports in report profile and data 1443, and sends the reports to the customer 1405. Example reports are shown in and described with reference to FIGS. 11-13. The report server 1440 may use all the monitor data or just relevant portions of it. In the case where the script gathers more than necessary data, the report server 1440 may discard the irrelevant data. However, should other reports be requested that uses currently irrelevant data, the report server 1440 will have access to the monitor data now deemed relevant.

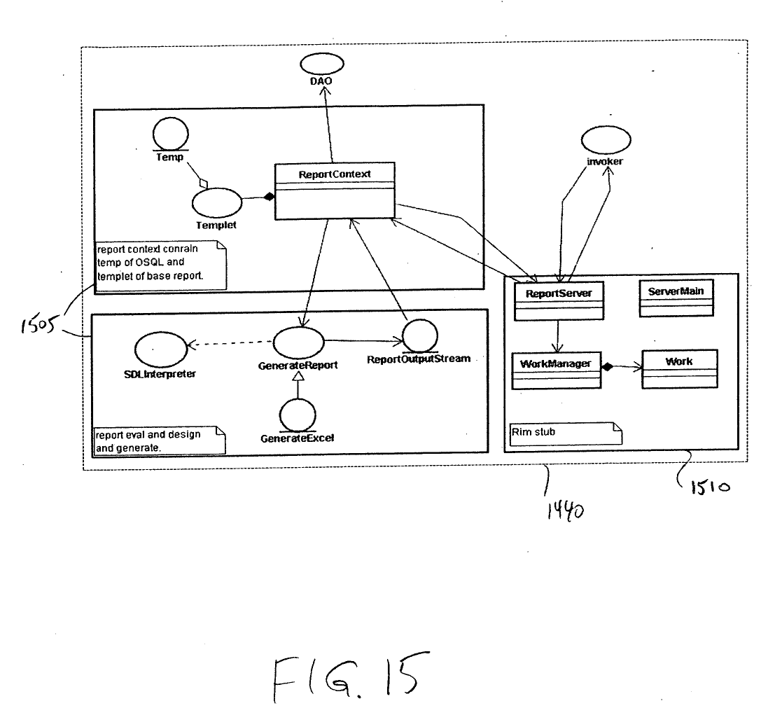

An example report server 1440 is described in greater detail with reference to FIG. 15. Report server 1440 generates customized reports, using flexible report metrics and report templates. To avoid unnecessary dependencies, the report server 1440 may be designed without vendor specific persistence-layer interface, but using XML-based translator scripts. In one embodiment, there are two functional components in the report server 1440, namely, a report calculator 1505 and a report task manager (RIM) 1510.

The report calculator 1505 component contains the following logic blocks:
1. ReportContext, which has the configuration and structure of report, including the report template, metric generation engine, SDL interpreter, and data-adaptation persistence.
2. Metric formula template, which is one per metric, based on the system definitions. Each report requires several metric formula templates to generate a complete report.
3. Report pre-process script, which is used to translate the report content into executable metric formula.
4. Excel Generator, which is used to generate Excel report.
5. SDL Interpreter, which is used to translate the script inside metric templates and Excel templates.

The RIM server 1510 is the main interface for all report operations interfacing with external requests & responses. The work operation is spurned whenever there is a report request, and work manager is used to managed all active report-work operations.

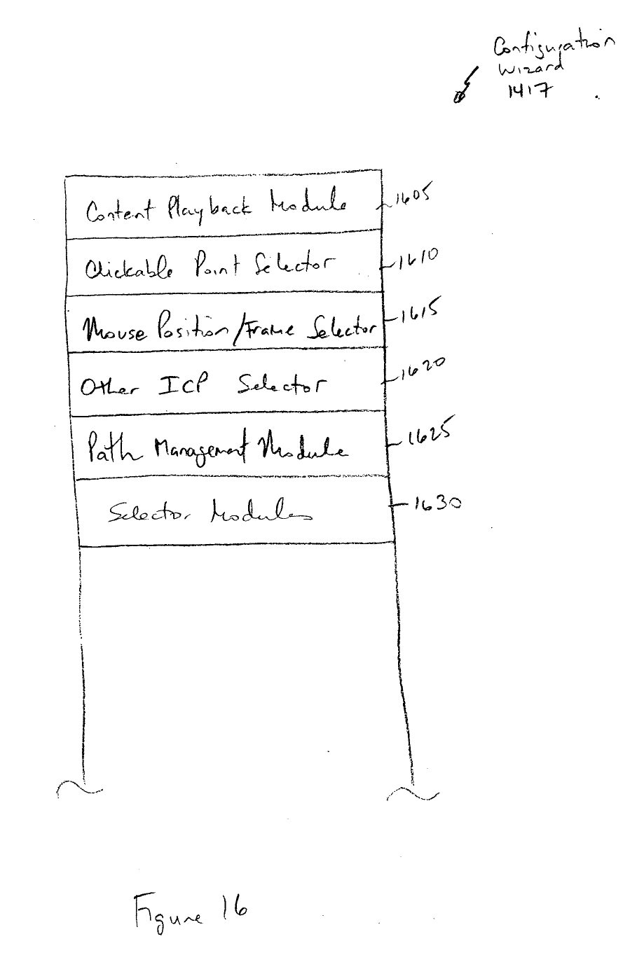

FIG. 16 is a block diagram illustrating details of the configuration wizard 1417. The configuration wizard 1417 decodes built-in static ICPs and allows the user to define a user-friendly name (label) for each control point, navigates the dynamic ICPs and allows user labeling, defines the interested monitor path from click point to click point, and/or defines the monitor area based on the selected ICP point and area range defined by mouse clicked position(s). The ICP data generated by the wizard 1417 may be used for customized report generation, to produce a report with only interested ICP control points, with user-friendly ICP labeling, and/or a monitor metric with specific interested path. The configuration wizard 1417 includes a media content playback module 1605 to enable playback of the media content, a clickable point selector 1610 to enable customer selection of clickable points of interest, a mouse position/frame selector module 1615 to enable customer selection of mouse movement at particular times during the playback, other interactivity control points of interest selector 1620 to enable customer selection of other “dynamic” ICPs, and a path management module 1625 to specify “label” data to the customer selected ICPs and the paths. The configuration wizard 1417 may include selector modules 1630 customized for a particular media content and/or “standard” selector modules for standard control points. Using the configuration wizard 1417, the customer reviews the media content, selects the ICPs of interest, and forwards the monitor configuration data to the other process modules, e.g., to the wrapper generator 1419, the remote client interface server 1432, and the report server 1440.

In one embodiment, if the media content only includes clickable hypertext and scroll bars, then “standard” selector modules may be all that is necessary. Clickable point selector 1610 and mouse position/frame selector 1615 are examples of “standard” selector modules. If the media content includes customized interaction points, such as unusual control methodology of a virtual automobile, then customized ICP selector modules may be needed to enable customer selection of those interactivity control points of interest. It should be appreciated that the term “standard” (possibly with quotes) herein is intended to identify modules developed in accordance with the present invention. for ICPs commonly seen. These “standard” selector modules can be reused for any media content. The term “standard” is not an indication that such selector modules are standard in the industry without the teachings of this invention.

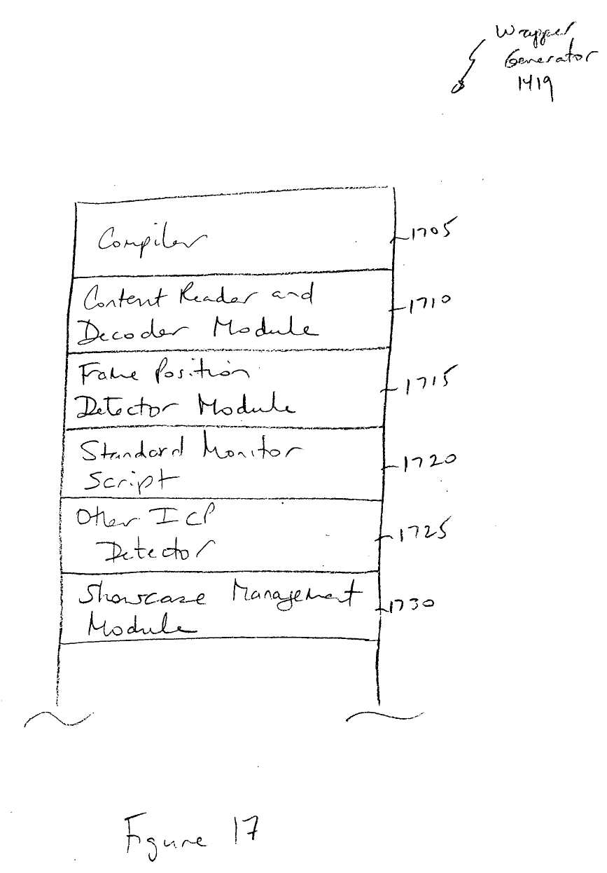

FIG. 17 is a block diagram illustrating details of the wrapper generator 1419. The wrapper generator 1419 includes a compiler 1705, a content reader & decoder module 1710, a frame position detector module 1715, standard monitor script 1720, other interactivity control points detector 1725 to enable “dynamic” ICPs, and a showcase management module 1730. The content reader and decoder module 1710 reads media and decodes the content. Content reader and decoder module 1710 may include a decompiler for decompiling the media content as needed (e.g., a Flash decompiler). The frame position detector 1715 enables the insertion of “standard” monitor action scripts 1720 and/or customized scripts 1725 into the proper framing location. In some embodiments, the frame detector 1715 may be a part of the decoder 1710. The “standard” scripts 1720 are developed for monitoring standard ICPs such as clickable points, mouse movement, etc., while other ICP detector 1725 is used for monitoring other interactive control points which are not commonly used action scripts. It should be appreciated that the term “standard” (possibly with quotes) herein is intended to identify scripts developed in accordance with the present invention for ICPs commonly seen. These “standard” scripts can be reused for any media content having standard ICPs. The term “standard” is not an indication that such scripts are standard in the industry without the teachings of this invention. The compiler 1705 enables compiling the scripts and/or recompiling any of the media content necessary for playback. The showcase management module 1730 enables storing the wrapped showcase, the wrapped profile, and transfer of the showcase to the relevant parties, such as the customer, the agent or the publisher.

FIG. 18 is a block diagram illustrating details of a wrapper 1800, which is attached to media content to generate the showcase. Although shown as a single unit, the wrapper 1800 may include various portions (also referred to as “scripts” or “modules”) attached to various points in the code making up the media content. The wrapper 1800 includes a default plug-in 1805, a client interface module 1810, a client control module (monitor script) 1815, basic configuration data 1820, data buffer 1830, and data transfer module 1835.

The plug-in 1805 enables communication with the remote client interface server 1432 for obtaining the latest client interface 1810, control script 1815, configuration data such as monitor setup, list of current monitor server 1430 locations, as well as the session control parameters, and data transfer protocol & transmission rules to be used by the data transfer module 1835. Per the configuration, the wrapper 1800 may include default configuration data 1820 which can be used to run independently, with the default setup of the client interface 1810, minimum client control module 1815, and default data transfer module 1835.

Once the downloaded client interface 1810 or the default configuration is running, whenever the client 1425 operates on an ICP or mouse movement, the client control module 1815 will generate a monitor record, with proper details, and store at the data buffer 1830. When the stored data reaches a specified limit, it will transmit the contents of the data buffer 1830 to the designated monitor server 1430 via data transfer module 1835 throughout the entire consumer session, per traffic configuration defined in the data transfer module 1835.

The client control module 1815 includes a mouse position monitor script, and a click behavior monitor script. It may also include other ICP monitor scripts. The control module 1815 may obtain all types of monitor information (records), but may only forward the relevant information to the data buffer 1830. Then, the report engine 1441 (see FIGS. 14 and 15) may only use the relevant monitor information. Information filtering can be applied on any type of data, including mouse movement, click, or other ICP behavior records.

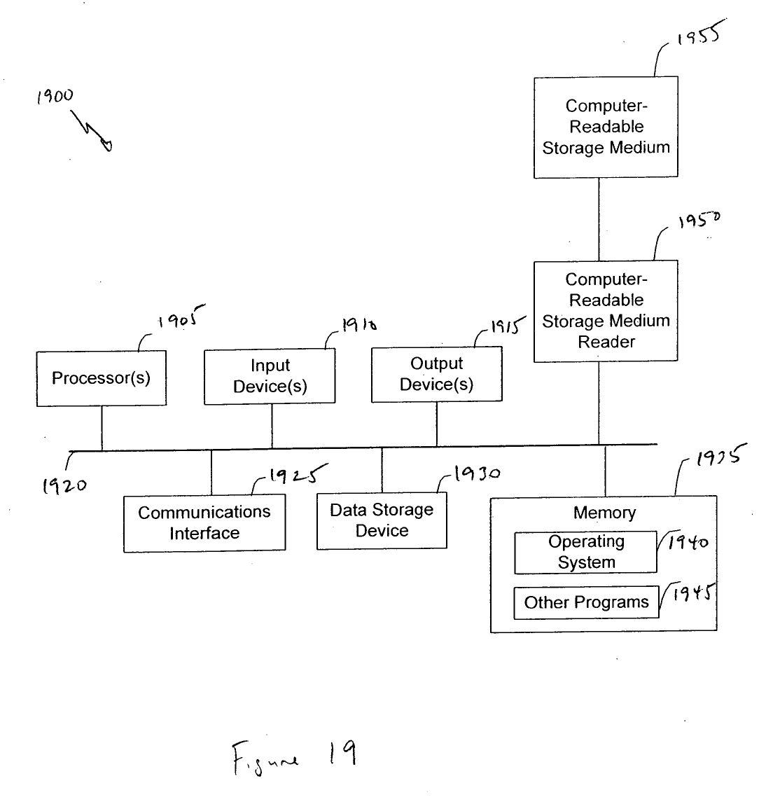

FIG. 19 is a block diagram illustrating details of an example computer system 1900, of which each client and each server is an instance. Computer system 1900 includes a processor 1905, such as an Intel Pentium® microprocessor or a Motorola Power PC® microprocessor, coupled to a communications channel 1920. The computer system 1900 further includes an input device 1910 such as a keyboard or mouse, an output device 1915 such as a cathode ray tube display, a communications device 1925, a data storage device 1930 such as a magnetic disk, and memory 1935 such as Random-Access Memory (RAM), each coupled to the communications channel 1920. The communications interface 1925 may be coupled to a network such as the wide-area network commonly referred to as the Internet. One skilled in the art will recognize that, although the data storage device 1930 and memory 1935 are illustrated as different units, the data storage device 1930 and memory 1935 can be parts of the same unit, distributed units, virtual memory, etc.

The data storage device 1930 and/or memory 1935 may store an operating system 1940 such as the Microsoft Windows NT or Windows/95 Operating System (OS), the IBM OS/2 operating system, the MAC OS, or UNIX operating system and/or other programs 1945. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 1900 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 1950 such as a magnetic disk drive, hard disk drive, magneto-optical reader, CPU, etc. may be coupled to the communications bus 1920 for reading a computer-readable storage medium (CRSM) 1955 such as a magnetic disk, a hard disk, a magneto-optical disk, RAM, etc. Accordingly, the computer system 1900 may receive programs and/or data via the CRSM reader 1950. Further, it will be appreciated that the term “memory” herein is intended to cover all data storage media whether permanent or temporary.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
enabling selection of interactivity control points of interest in media content;
forwarding identification of at least one interactivity control point of interest to a wrapper generator; and
attaching at least one script into the media content to monitor the at least one interactivity control point of interest when the media content is executed.

2. The method of claim 1, wherein the interactivity control points include clickable points and mouse movement.

3. The method of claim 1, wherein the media content includes Flash media.

4. The method of claim 1, wherein the at least one script is capable of monitoring all instances of consumer interaction with the interactivity control points occurring during media content playback.

5. The method of claim 4, further comprising generating configuration data for configuring the script to monitor only a portion of the instances of the consumer interaction with the interactivity control points occurring during media content playback.

6. The method of claim 5, wherein the portion of the instances is determined by the customer on a point-by-point basis.

7. A system comprising:
a selector for enabling selection of interactivity control points of interest in media content;
a data management module for forwarding identification of at least one interactivity control point of interest to a wrapper generator; and
a wrapper generator for attaching at least one script to the media content to monitor the at least one interactivity control point of interest when the media content is executed.

8. The system of claim 7, wherein the interactivity control points include clickable points and mouse movement.

9. The system of claim 7, wherein the media content includes Flash media.

10. The system of claim 7, wherein the at least one script is capable of monitoring all instances of consumer interaction with the interactivity control points occurring during media content playback.

11. The system of claim 10, further comprising a configuration wizard capable of generating configuration data for configuring the script to monitor only a portion of the instances of the consumer interaction with the interactivity control points occurring during media content playback.

12. The system of claim 11, wherein the portion of the instances is determined by the customer on a point-by-point basis.

13. A method comprising:
receiving media content having at least one attached script capable of monitoring interactivity control points;
obtaining configuration data identifying which interactivity control points to monitor;
configuring the script to monitor at least one interactivity control point in accordance with the configuration data; and
executing the media content and the configured script.

14. The method of claim 13, wherein the script is configured to monitor interactivity control points including clickable points and mouse movement.

15. The method of claim 13, wherein the media content includes Flash media.

16. The method of claim 13, wherein the at least one attached script is capable of monitoring all instances of consumer interaction with the interactivity control points occurring during media content playback.

17. A system comprising:
media content having at least one attached script capable of monitoring interactivity control points;
configuration data identifying which interactivity control points to monitor, the attached script including address information for identifying the configuration data; and
a browser for downloading the media content and the configuration data and for executing the media content and the attached script, the execution of the attached script dynamically configuring the script to monitor at least one interactivity control point.

18. The system of claim 17, wherein the attached script is configured to monitor interactivity control points including clickable points and mouse movement.

19. The system of claim 17, wherein the media content includes Flash media.

20. The system of claim 17, wherein the attached script is capable of monitoring all instances of consumer interaction with the interactivity control points occurring during media content playback.

21. The system of claim 20, wherein the configuration data identifies a subset of all instances of consumer interaction to monitor.
